(19) United States
(12) Patent Application Publication
(10) Pub. No.: US 2015/0348587 A1
(43) Pub. Date: Dec. 3, 2015

(54) METHOD AND APPARATUS FOR WEIGHTED MEDIA CONTENT REDUCTION

(71) Applicant: Thomson Licensing, Issy de Moulineaux (FR)

(72) Inventor: Neil D. VOSS, Darien, CT (US)

(21) Appl. No.: 14/471,827

(22) Filed: Aug. 28, 2014

Related U.S. Application Data
(60) Provisional application No. 62/003,281, filed on May 27, 2014.
(60) Provisional application No. 62/041,898, filed on Aug. 26, 2014.

(51) Int. Cl. G11B 27/00; H04N 9/80; H04N 5/77; G11B 27/031; G11B 27/30

(52) U.S. Cl. CPC G11B 27/002; G11B 27/031; G11B 27/30; H04N 5/772; H04N 9/80

(57) ABSTRACT

A method of segmenting a set of media recordings captured by a media device includes retrieving the set of media recordings from memory and determining characteristics of the media recordings. Weights for the characteristics are applied and used in generation of one or more segments representing the set of video recordings.

### CROSS REFERENCE TO RELATED APPLICATIONS

This application claims priority from U.S. Provisional Application No. 62/003,281 filed May 27, 2014 having attorney docket number PU140089 and U.S. Provisional Application No. 62/041,898 filed Aug. 26, 2014 having attorney docket number PU140117.

### FIELD

The present disclosure relates to video processing system. Specifically, the disclosure relates to a technique to compress video in segments to a particular time length.

### BACKGROUND

Portable electronic devices are becoming more ubiquitous. These devices, such as mobile phones, music players, cameras, tablets and the like often contain a combination of devices, thus rendering carrying multiple objects redundant. For example, current touch screen mobile phones, such as the Apple™ iPhone™ or Samsung™ Galaxy™ android phone contain video and still cameras, global positioning navigation system, internet browser, text and telephone, video and music player, and more. These devices are often enabled on multiple networks, such as WiFi™, wired, and cellular, such as 3GTM, 4GTM, and LTE™, to transmit and receive data.

The quality of secondary features in portable electronics has been constantly improving. For example, early “camera phones” consisted of low resolution sensors with fixed focus lenses and no flash. Today, many mobile phones include full high definition video capabilities, editing and filtering tools, as well as high definition displays. With this improved capabilities, many users are using these devices as their primary photography devices. Hence, there is a demand for even more improved performance and professional grade embedded photography tools. Additionally, users wish to share their content with others in more ways that just printed photographs. These methods of sharing may include email, text, or social media websites, such as Facebook™ Twitter™, YouTube™ and the like.

Users may wish to share and view video content easily and quickly. Today, users must upload content to a video storage site or a social media site, such as YouTube™. However, if the videos are too long, users must edit the content in a separate program prior to upload to make the video short enough for easy and quick viewing. These features are not commonly available on mobile devices, so users must first download the content to a computer to perform the editing which can include shortening a video. As this is often beyond either the skill level of the user, or requires too much time and effort to be practical, users often are dissuaded from sharing video content that the user feels is too long to be viewed easily and quickly. Thus, it is desirable to overcome these problems with current cameras and software embedded in mobile electronic devices.

### SUMMARY

This summary is provided to introduce a selection of concepts in a simplified form that are further described below in the Detailed Description. The Summary is not intended to identify key features or essential features of the claimed subject matter, not is it intended to be used to limit the scope of the claimed subject matter.

According to aspects described herein, a method of segmenting a set of media recordings occurs in a media device. Initially, a set of media recordings is captured and stored into memory on the media device. The set of media recordings is retrieved from memory and searched for characteristics of the media recordings. Various weights are established for the characteristics. In one embodiment, an order of presentation is also established. The set of media recordings are segmented and constructed according to the weighting of the characteristics. The result is a segmented version of the set of media recordings. The segments can be played back played back using the media device.

### BRIEF DESCRIPTION OF THE DRAWINGS

These and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an exemplary embodiment of mobile electronic device;

FIG. 2 shows an exemplary mobile device display having an active display;

FIG. 3 shows an exemplary process for image stabilization and reframing;

FIG. 4 shows an exemplary mobile device display having a capture initialization 400;

FIG. 5 shows an exemplary process for initiating an image or video capture 500;

FIG. 6a shows a first example set of media recordings and a first possible example segmentation according to aspects of the invention;

FIG. 6b shows a first example set of media recordings and a second possible example segmentation according to aspects of the invention;

FIG. 6c shows a first example set of media recordings and a third possible example segmentation according to aspects of the invention;

FIG. 6d shows a second example set of media recordings and a first possible segmentation and ordering according to aspects of the invention;

FIG. 6e shows a second example set of media recordings and a second possible segmentation and ordering according to aspects of the invention;

FIG. 6f shows a second example set of media recordings and a third possible segmentation and ordering according to aspects of the invention; and

FIG. 7 illustrates a first example method using aspects of the invention; and

FIG. 8 illustrates a second example method using aspects of the invention.

### DETAILED DISCUSSION OF THE EMBODIMENTS

The exemplifications set out herein illustrate preferred embodiments of the invention, and such exemplifications are not to be construed as limiting the scope of the invention in any manner.

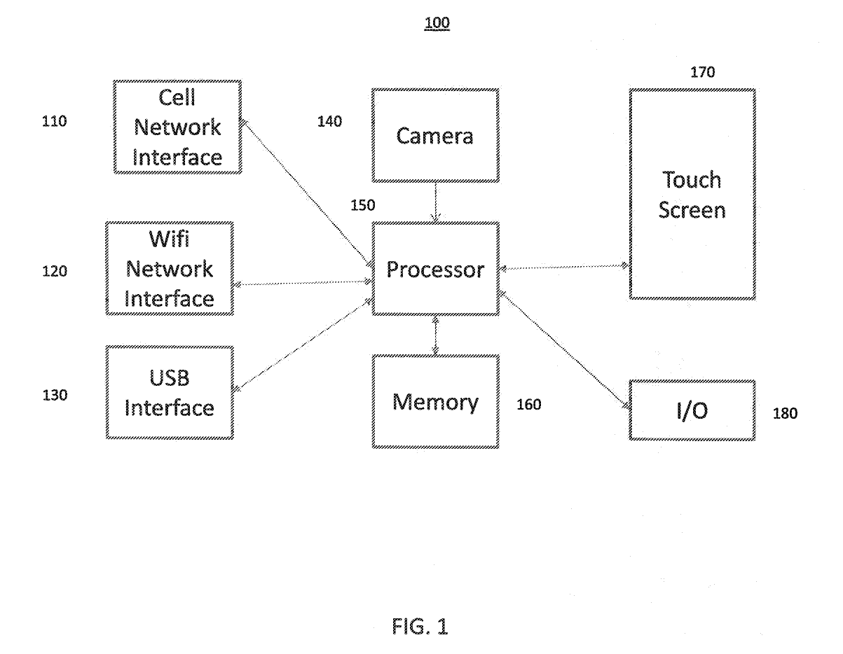

Referring to FIG. 1, a block diagram of an exemplary embodiment of mobile electronic device is shown. While the depicted mobile electronic device is a mobile phone 100, the invention may equally be implemented on any number of devices, such as music players, cameras, tablets, global positioning navigation systems, etc. A mobile phone typically includes the ability to send and receive phone calls and text messages, interface with the Internet either through the cellular network or a local wireless network, take pictures and videos, play back audio and video content, and run applications such as word processing, programs, or video games. Many mobile phones include GPS and also include a touch screen panel as part of the user interface.

The mobile phone includes a main processor 150 that is coupled to each of the other major components. The main processor, or processors, routes the information between the various components, such as the network interfaces, camera 140, touch screen 170, and other input/output I/O interfaces 180. The main processor 150 also processes audio and video content for play back either directly on the device or on an external device through the audio/video interface. The main processor 150 is operative to control the various sub devices, such as the camera 140, touch screen 170, and the USB interface 130. The main processor 150 is further operative to execute subroutines in the mobile phone used to manipulate data similar to a computer. For example, the main processor may be used to manipulate image files after a photo has been taken by the camera function 140. These manipulations may include cropping, compression, color and brightness adjustment, and the like.

The cell network interface 110 is controlled by the main processor 150 and is used to receive and transmit information over a cellular wireless network. This information may be encoded in various formats, such as time division multiple access (TDMA), code division multiple access (CDMA) or orthogonal frequency-division multiplexing (OFDM). Information is transmitted and received from the device trough a cell network interface 110. The interface may consist of multiple antennas encoders, demodulators and the like used to encode and decode information into the appropriate formats for transmission. The cell network interface 110 may be used to facilitate voice or text transmissions, or transmit and receive information from the internet. This information may include video, audio, and or images.

The wireless network interface 120, or WiFi™ network interface, is used to transmit and receive information over a WiFi™ network. This information can be encoded in various formats according to different WiFi™ standards, such as IEEE 802.11g, IEEE 802.11b, IEEE 802.11ac and the like. The interface may consist of multiple antennas encoders, demodulators and the like used to encode and decode information into the appropriate formats for transmission and decode information for demodulation. The WiFi™ network interface 120 may be used to facilitate voice or text transmissions, or transmit and receive information from the internet. This information may include video, audio, and or images.

The universal serial bus (USB) interface 130 is used to transmit and receive information over a wired link, typically to a computer or other USB enabled device. The USB interface 120 can be used to transmit and receive information, connect to the internet, transmit and receive voice and text calls. Additionally, this wired link may be used to connect the USB enabled device to another network using the mobile devices cell network interface 110 or the WiFi™ network interface 120. The USB interface 120 can be used by the main processor 150 to send and receive configuration information to a computer.

A memory 160, or storage device, may be coupled to the main processor 150. The memory 160 may be used for storing specific information related to operation of the mobile device and needed by the main processor 150. The memory 160 may be used for storing audio, video, photos, or other data stored and retrieved by a user.

The input output (I/O) interface 180, includes buttons, a speaker/microphone for use with phone calls, audio recording and playback, or voice activation control. The mobile device may include a touch screen 170 coupled to the main processor 150 through a touch screen controller. The touch screen 170 may be either a single touch or multi touch screen using one or more of a capacitive and resistive touch sensor. The mobile phone may also include additional user controls such as but not limited to an on/off button, an activation button, volume controls, ringer controls, and a multi-button keypad or keyboard.

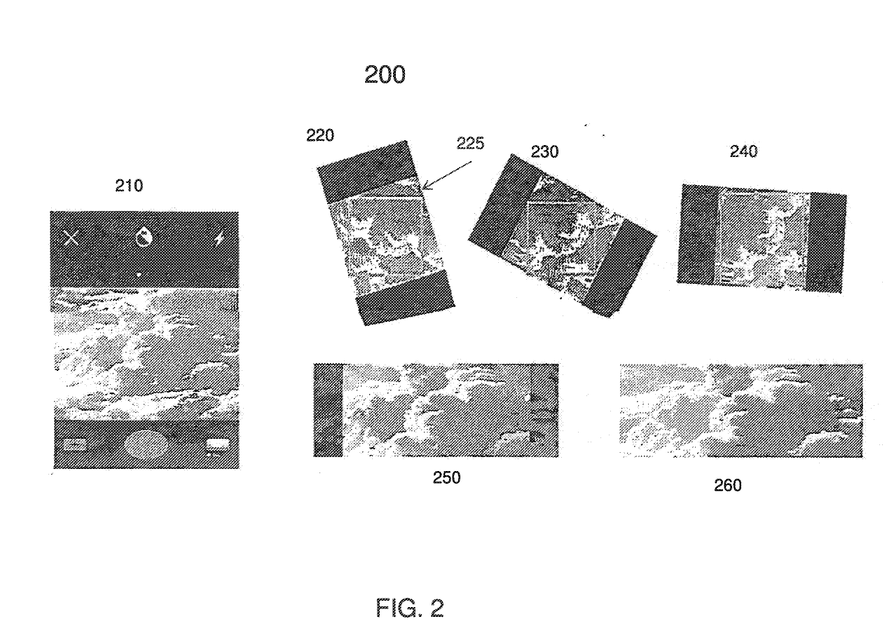

Turning now to FIG. 2 an exemplary mobile device display having an active display 200 according to the present invention is shown. The exemplary mobile device application is operative for allowing a user to record in any framing and freely rotate their device while shooting, visualizing the final output in an overlay on the device's viewfinder during shooting and ultimately correcting for their orientation in the final output.

According to the exemplary embodiment, when a user begins shooting, their current orientation is taken into account and the vector of gravity based on the device's sensors is used to register a horizon. For each possible orientation, such as portrait 210, where the device's screen and related optical sensor is taller than wide, or landscape 250, where the device's screen and related optical sensor is wider than tall, an optimal target aspect ratio is chosen. An inset rectangle 225 is inscribed within the overall sensor that is best-fit to the maximum boundaries of the sensor given the desired optimal aspect ratio for the given (current) orientation. The boundaries of the sensor are slightly padded in order to provide ‘breathing room’ for correction. This inset rectangle 225 is transformed to compensate for rotation 220, 230, 240 by essentially rotating in the inverse of the device's own rotation, which is sampled from the device's integrated gyroscope. The transformed inner rectangle 225 is inscribed optimally inside the maximum available bounds of the overall sensor minus the padding. Depending on the device's current most orientation, the dimensions of the transformed inner rectangle 225 are adjusted to interpolate between the two optimal aspect ratios, relative to the amount of rotation.

For example, if the optimal aspect ratio selected for portrait orientation was square (1:1) and the optimal aspect ratio selected for landscape orientation was wide (16:9), the inscribed rectangle would interpolate optimally between 1:1 and 16:9 as it is rotated from one orientation to another. The inscribed rectangle is sampled and then transformed to fit an optimal output dimension. For example, if the optimal output dimension is 4:3 and the sampled rectangle is 1:1, the sampled rectangle would either be aspect filled (fully filling the 1:1 area optically, cropping data as necessary) or aspect fit (fully fitting inside the 1:1 area optically, blacking out any unused area with ‘letter boxing’ or ‘pillar boxing’. In the end the result is a fixed aspect asset where the content framing adjusts based on the dynamically provided aspect ratio during correction. So for example a 16:9 video comprised of 1:1 to 16:9 content would oscillate between being optically filled 260 (during 16:9 portions) and fit with pillar boxing 250 (during 1:1 portions).

Additional refinements whereby the total aggregate of all movement is considered and weighed into the selection of optimal output aspect ratio are in place. For example, if a user records a video that is ‘mostly landscape’ with a minority of portrait content, the output format will be a landscape aspect ratio (pillar boxing the portrait segments). If a user records a video that is mostly portrait the opposite applies (the video will be portrait and fill the output optically, cropping any landscape content that falls outside the bounds of the output rectangle).

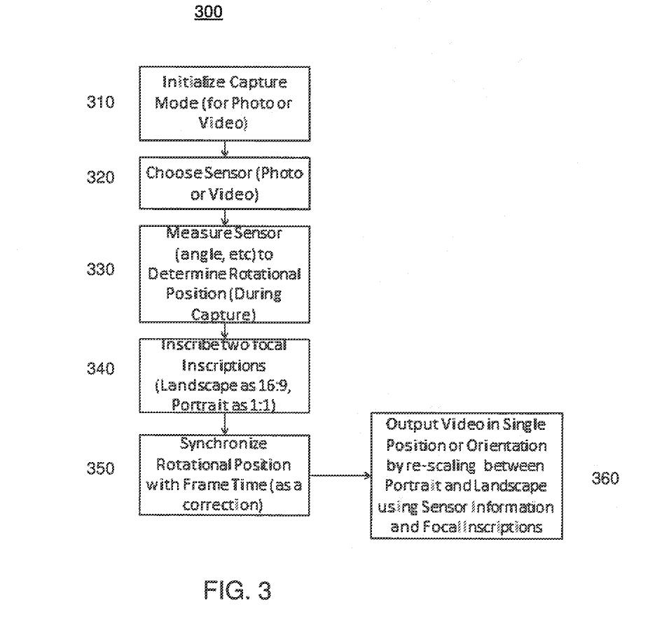

Referring now to FIG. 3, an exemplary process for image stabilization and reframing 300 in accordance with the present disclosure is shown. The system is initialized in response to the capture mode of the camera being initiated. This initialization may be initiated according to a hardware or software button, or in response to another control signal generated in response to a user action. Once the capture mode of the device is initiated, the mobile device sensor 320 is chosen in response to user selections. User selections may be made through a setting on the touch screen device, through a menu system, or in response to how the button is actuated. For example, a button that is pushed once may select a photo sensor, while a button that is held down continuously may indicate a video sensor. Additionally, holding a button for a predetermined time, such as 3 seconds, may indicate that a video has been selected and video recording on the mobile device will continue until the button is actuated a second time.

Once the appropriate capture sensor is selected, the system then requests a measurement from a rotational sensor 320. The rotational sensor may be a gyroscope, accelerometer, axis orientation sensor, light sensor or the like, which is used to determine a horizontal and/or vertical indication of the position of the mobile device. The measurement sensor may send periodic measurements to the controlling processor thereby continuously indicating the vertical and/or horizontal orientation of the mobile device. Thus, as the device is rotated, the controlling processor can continuously update the display and save the video or image in a way which has a continuous consistent horizon.

After the rotational sensor has returned an indication of the vertical and/or horizontal orientation of the mobile device, the mobile device depicts an inset rectangle on the display indicating the captured orientation of the video or image 340. As the mobile device is rotated, the system processor continuously synchronizes inset rectangle with the rotational measurement received from the rotational sensor 350. They user may optionally indicate a preferred final video or image ration, such as 1:1, 9:16, 16:9, or any ratio decided by the user. The system may also store user selections for different ratios according to orientation of the mobile device. For example, the user may indicate a 1:1 ratio for video recorded in the vertical orientation, but a 16:9 ratio for video recorded in the horizontal orientation. In this instance, the system may continuously or incrementally rescale video 360 as the mobile device is rotated. Thus a video may start out with a 1:1 orientation, but could gradually be rescaled to end in a 16:9 orientation in response to a user rotating from a vertical to horizontal orientation while filming. Optionally, a user may indicate that the beginning or ending orientation determines the final ratio of the video.

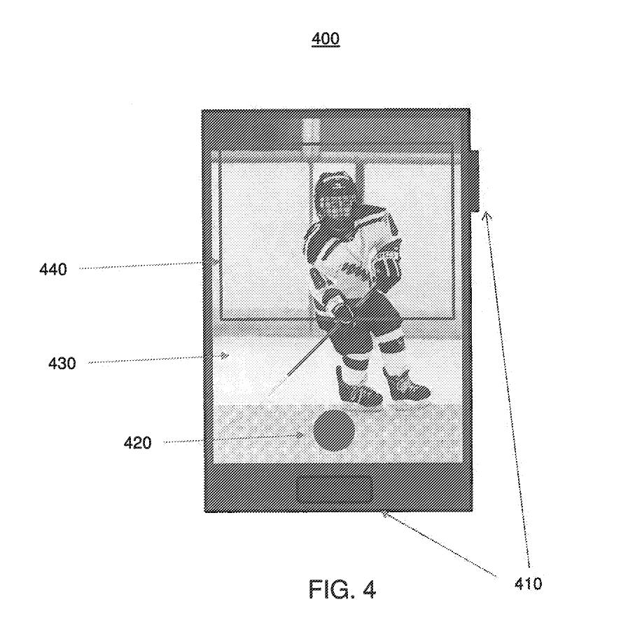

Turning now to FIG. 4, an exemplary mobile device display having a capture initialization 400 according to the present invention is shown. An exemplary mobile device is show depicting a touch tone display for capturing images or video. According to an aspect of the present invention, the capture mode of the exemplary device may be initiated in response to a number of actions. Any of hardware buttons 410 of the mobile device may be depressed to initiate the capture sequence. Alternatively, a software button 420 may be activated through the touch screen to initiate the capture sequence. The software button 420 may be overlaid on the image 430 displayed on the touch screen. The image 430 acts as a viewfinder indicating the current image being captured by the image sensor. An inscribed rectangle 440 as described previous may also be overlaid on the image to indicate an aspect ratio of the image or video be captured.

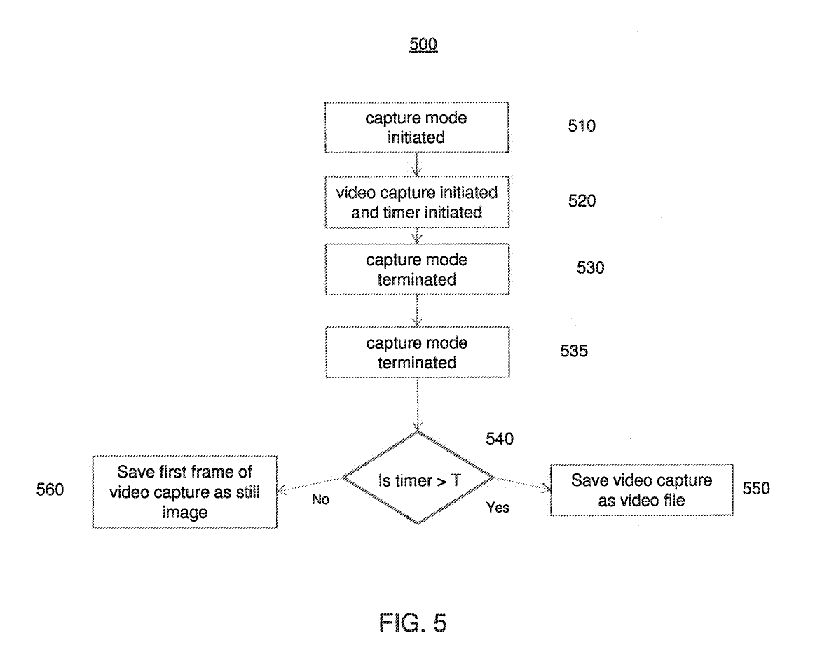

Referring now to FIG. 5, an exemplary process for initiating an image or video capture 500 in accordance with the present disclosure is shown. Once the imaging software has been initiated, the system waits for an indication to initiate image capture. Once the image capture indication has been received by the main processor 510, the device begins to save the data sent from the image sensor 520. In addition, the system initiates a timer. The system then continues to capture data from the image sensor as video data. In response to a second indication from the capture indication, indicating that capture has been ceased 530, the system stops saving data from the image sensor and stops the timer.

The system then compares the timer value to a predetermined time threshold 540. The predetermined time threshold may be a default value determined by the software provider, such as 1 second for example, or it may be a configurable setting determined by a user. If the timer value is less than the predetermined threshold 540, the system determines that a still image was desired and saves the first frame of the video capture as a still image in a still image format, such as jpeg or the like 560. The system may optionally choose another frame as the still image. If the timer value is greater than the predetermined threshold 540, the system determines that a video capture was desired. The system then saves the capture data as a video file in a video file format, such as mpeg or the like 550. The system then may then return to the initialization mode, waiting for the capture mode to be initiated again. If the mobile device is equipped with different sensors for still image capture and video capture, the system may optionally save a still image from the still image sensor and start saving capture data from the video image sensor. When the timer value is compared to the predetermined time threshold, the desired data is saved, while the unwanted data is not saved. For example, if the timer value exceeds the threshold time value, the video data is saved and the image data is discarded.

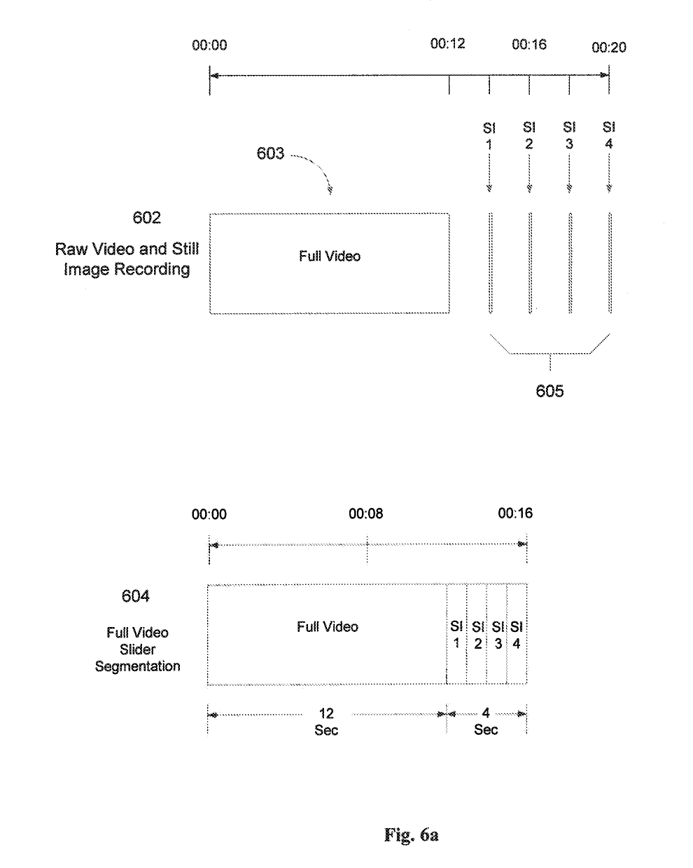

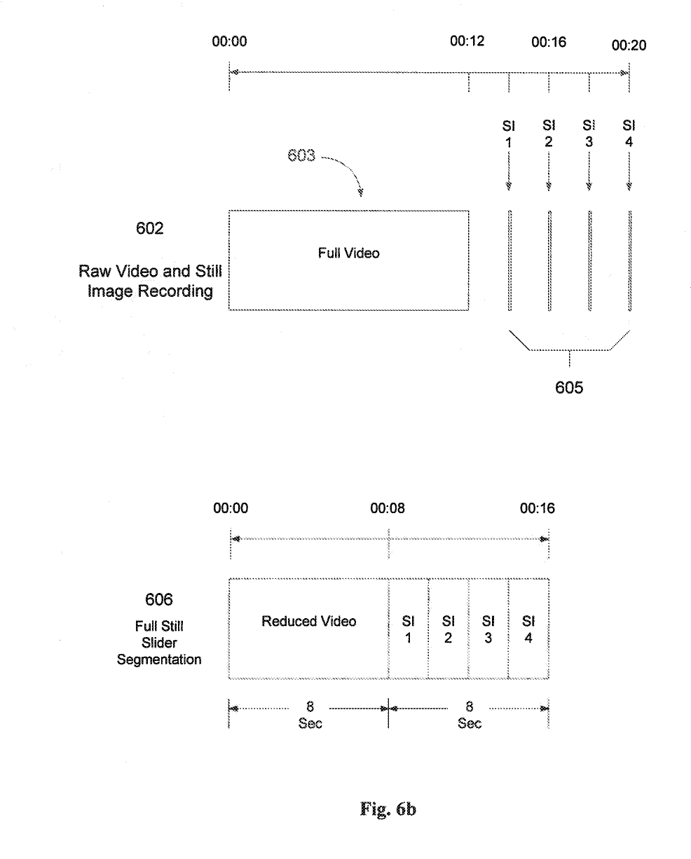

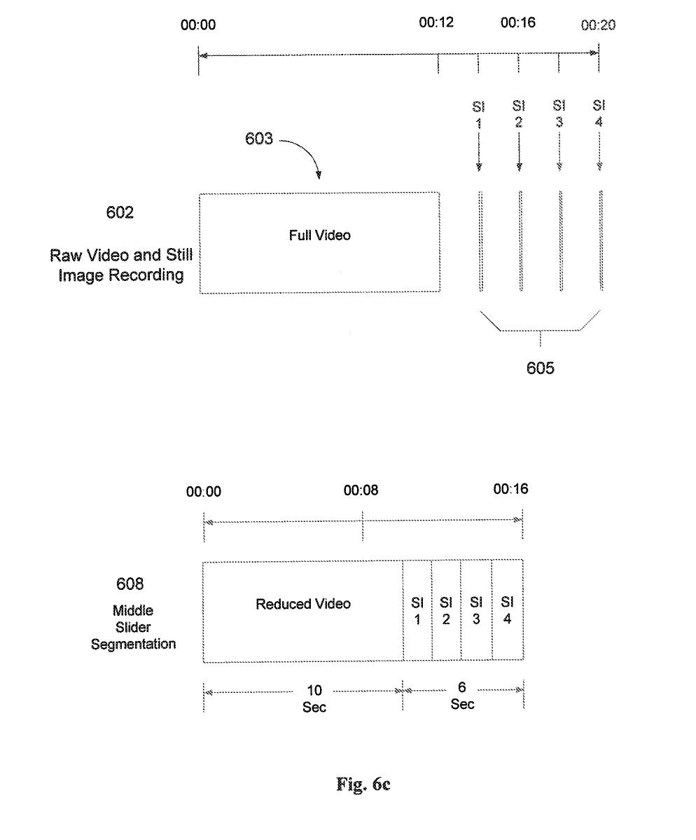

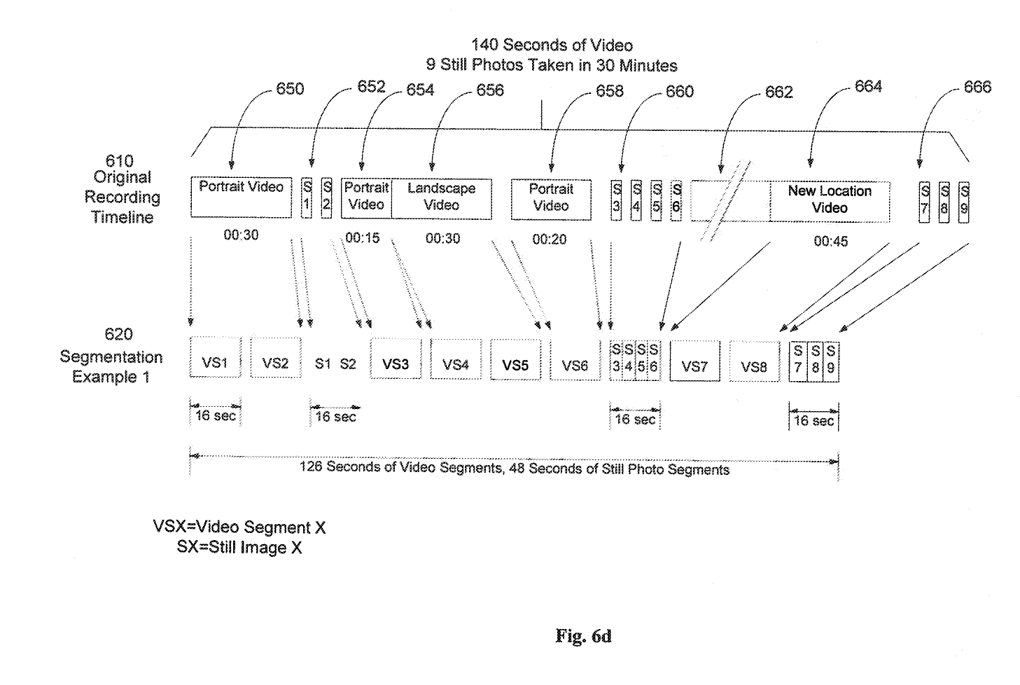

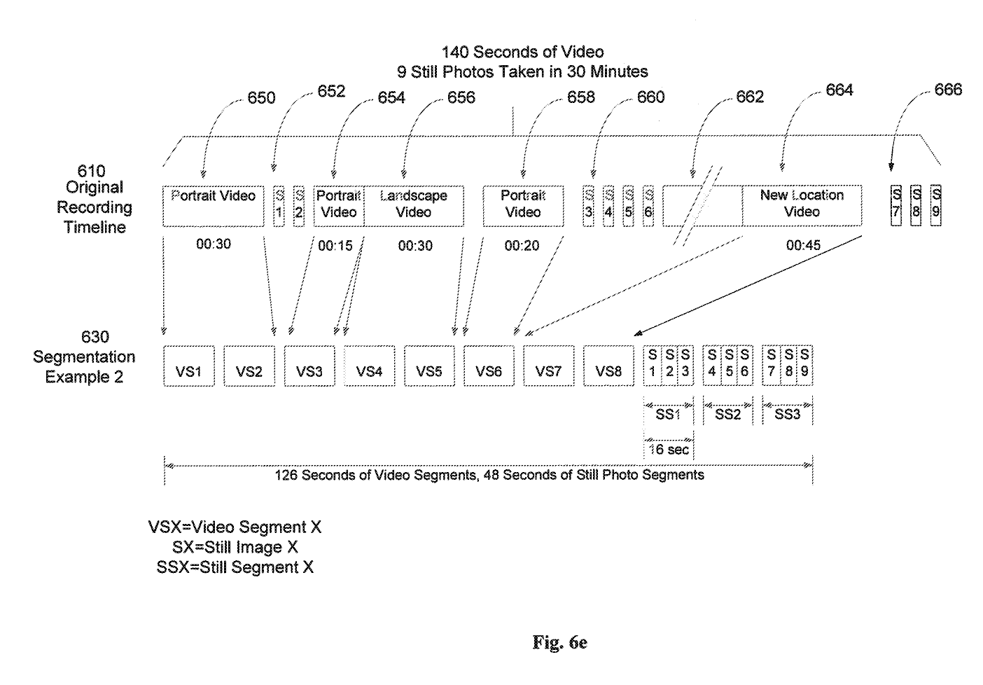

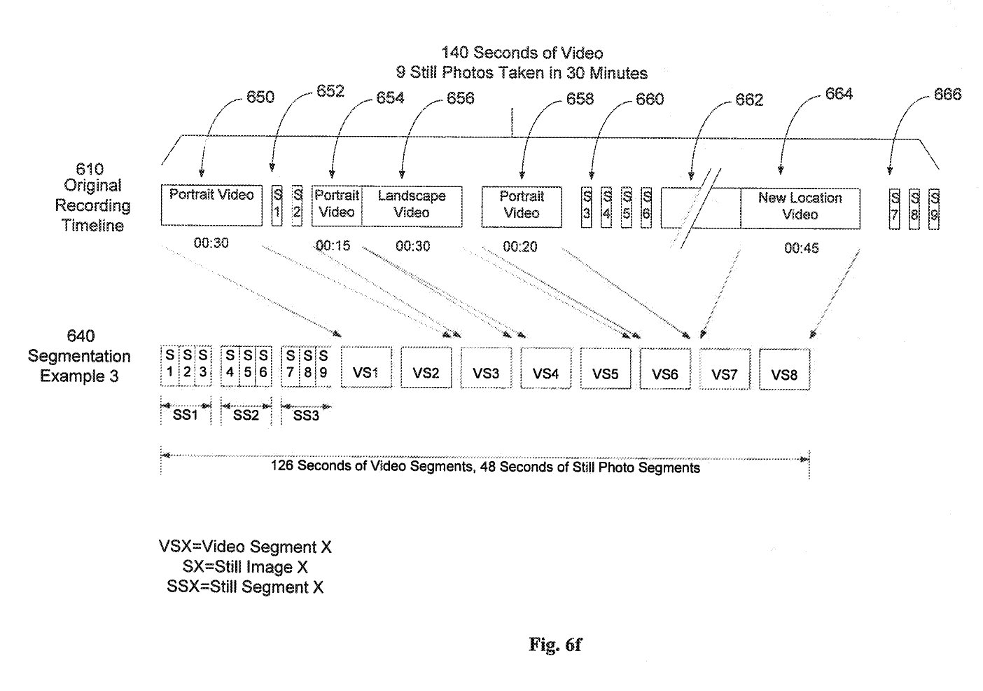

FIG. 6a illustrates a first example set of media recordings and a first segmentation example according to one aspect of the invention. The raw video and still image recording 602 results is an example first set of media recordings using a media device, such as media device 400. A user operating media device 400 can use a button, such as software button 420 on the media device to capture media recordings such as the set of media recordings 602 depicted in FIG. 6a. In one possible operation, a user would hold a capture control button, or other media capture control mechanism, and start capturing and recording video. If a user held or actuated the capture control button 420 of the media device for 12 seconds, then the full video portion 603 of the set of media recordings 602 can be captured. The time indices of FIG. 6a indicates that the raw recorded video 603 is 12 seconds in duration. The user released the capture button at the 12 second mark. Two seconds later, the user tapped the capture button 420 and the media device 400 effectively recorded a still image S1 at the 14 second mark. Two second later, at the 16 second mark, the user once again tapped the capture button 420 and a second still image S2 is captured. Two second later, at the 18 second mark, the user once again tapped the capture button 420 and a third still image S3 is captured. Finally, two second later, at the 20 second mark, the user once again tapped the capture button 420 and a fourth still image S4 is captured. The full raw video 606 and the set of four still images 605 together make up the first example set of media recordings 602. Note that the fill set of recordings is 20 seconds in capture time. According to an embodiment of the invention, such raw media recordings 602 is segmented into 16 a second segment. Thus, according to how the segmentation is accomplished, video or still captures may be reduced or expanded to fit into a 16 second segment.

In one aspect of the invention, media device 400 has a control, not shown in FIG. 4, termed a slide bar control, as is well known in the art. Typically, slide bar controls allow a user to use a finger on a touch screen device to control a quantity between two limits that are represented by the two opposite ends of the slide bar control. For example, the slide bar control may be a soft control displayed on a touch screen of the media device 400. This slide bar control can appear on a user interface after the set of media recordings is captured. That is, the slide bar control would appear on an editing screen view prior to segmentation of the set of media recordings. The slide bar control allows the user to select how the weighting of the media recordings is performed for segmentation of the set of media recordings. Although not shown, in one embodiment, the slide bar control is horizontal with respect to the user view. Being horizontal, the slide bar control has two end limits; one limit on the left, one limit on the right. A position between the two ends selects a value between the two limits. In the current example, on the edit display screen that shows the slide bar control, a left side end may be marked “full video”. The right side end of the slide bar control may be marked “full still image”. The slide bar control allows the user to control weighting used during segmentation by allowing the user to choose a relative proportion of video portion of recording to still image portion of recording for insertion into a 16 second segment. Essentially, the slide bar control applies a weighting to the set of media recordings for segmentation purposes. The slide bar control allows a user to select a value of weighting between a “full video” limit and a “full still image” limit. The slide bar control is a control input for the determination of weighting of media type.

Thus, if the user moved the slide bar control all the way to the left (“full video”), then the full raw video 603 is weighted higher than the set of stills 605. If the slide bar control is moved all the way to the right (“full still image”), then the set of still images 605 would be weighted higher than the video portion 603. In weighting, the segmentation depicted in FIG. 6a honors and preserves the chronological order of the media recordings. That is, the video 603 is ordered to the first in time before the stills in the segmentation. Also, the fidelity of the timing is preserved as much as possible according to the weighting applied by the slide bar control. This includes the spacing between stills.

A first example segmentation according to a weighting using the slide bar control is shown in FIG. 6a in segment 604. In this instance the segmentation 604 is performed assuming the slide bar control is fully to the indicating a “full video” user preference characteristic. In the segmentation 604, the 12 second long raw video 603 that was captured is inserted into segment 604 first in full because the slide control bar weighted the “full video” much more heavily than the stills. The stills S1, S2, S3, and S4 are then inserted in order in the remaining four second of the 16 second segment 604. Each of the stills is expanded to fill the remaining four seconds at one second each. However, because the slide control bar position weighted still images lightly and video images heavily, then the 2 second spacing between each of the still images is reduced to a one second spacing. Accordingly, because of the slide bar control position being at the left most “full video” position, the full video portion 603 timing and content was preserved. However, the still image set 605 timing was not preserved and was reduced to fit into the 16 second segment 604.

FIG. 6b illustrates the same first example set of media recordings 602 that is shown in FIG. 6a and a second segmentation example 606 according to one aspect of the invention. As in FIG. 6a, the raw video and still image recording 602 results is an example first set of media recordings using a media device, such as media device 400. In the example segmentation of FIG. 6b, the slide bar control (not shown) that can be displayed on the touch screen of media device 400 is positioned all the way to the right indicating the “full still image” position. This position is a user preference to weight the still images in their full original timing form 605 in the generation of a 16 second segment.

Segment 606 is the result of segmentation where the slider bar control weights the still images 605 much more heavily than that of the video portion 603. The result is that the two second spacing between stills that exists in the raw still timing 605 is preserved in the segment 606. This spacing preservation results in 8 seconds of stills where each still is expanded to be two seconds each as shown in segmentation 606. As a consequence, this leaves only 8 seconds for the video 603 to be inserted into segment 606. Thus, raw video portion 603 must be reduced to 8 seconds in order to fit into segment 606. According to an aspect of the invention, video 603 may be reduced from 12 seconds to 8 seconds by removing frames that are repetitive or that have very little motion from one frame to the next. The results is the construction of segment 606 which preserves the chronological order of the set of media recordings 602, but that places weighted emphasis on the content and timing of the still images in the set of media recordings 602.

FIG. 6c illustrates the same first example set of media recordings 602 that is shown in FIG. 6a and a third segmentation example 608 according to one aspect of the invention. As in FIG. 6a, the raw video and still image recording 602 results is an example first set of media recordings using a media device, such as media device 400. In the example segmentation of FIG. 6c, the slide bar control (not shown) that can be displayed on the touch screen of media device 400 is positioned roughly in the middle position between “full video” and “full still image”. This position is a user preference to weight the video and the still images in about the same value in generation of the 16 second segment.

Segment 608 is the result of segmentation where the slider bar control weights the still images 605 in roughly the same amount as the video portion 603. The result is that the two second timing spacing between stills that exists in the raw still timing 605 is reduced to about 1.5 seconds in the segment 606. This spacing results in 6 seconds of stills. Also, the video portion 603 is also reduced from 12 seconds to about 10 seconds. According to an aspect of the invention, video 603 may be reduced from 12 seconds to 10 seconds by removing frames that are repetitive or that have very little motion from one frame to the next. The result is the construction of segment 608 which preserves the chronological order of the set of media recordings 602, but that places roughly equal weighted emphasis on the content and timing of the video 603 and still images 605.

Although the example set of media recordings 602 shown in examples of FIGS. 6a, 6b, and 6c resulted in one segment (604, 606, or 608 respectively), one of skill in the art will recognize that multiple segments may be generated. For example, if the set of media recordings 602 was more voluminous, then the segmentation process could have resulted in multiple 16 second segments. Such multiple segment examples are considered in the example of FIGS. 6d, 6e, and 6f below along with further variations in the segmentation process.

In another aspect of the invention, segmentation of a set of media recordings can occur based on a weighted characteristic of the recordings and a user preference for order of presentation. These concepts are presented in FIGS. 6d, 6e, and 6f. FIG. 6d illustrates a second example set of media recordings and a first example of an ordering and segmentation according to aspects of the invention. An original recording timeline 610 is shown in FIG. 6d. The recording is made by a media device, such as a mobile phone, hand held camera, tablet, or any other media device having a camera, such as that shown in FIG. 1. The entire timeline 610 represents a possible set of recordings made with the media device. Here, a user first captures or records a video 650 using a portrait orientation on the media device. The orientation sensor of the media device is recorded as part of the video recording in the form of auxiliary information associated with the recording portion 650 and is stored in memory along with the video recorded in the portrait video recording portion 650. The portrait video is 30 seconds in duration.

The user of the media device then stopped recording video, waited a period of time, possibly moving his/her location, and captured two still photos using the still photo camera function of the media device. The still photos or still images 652 are labeled S1 and S2. Once again there is a time break before the next video event is recorded.

The media device then captures a second portrait video 654. This video, possibly of a different subject than that of 650 or 652, or in a different location, is 15 seconds in duration. The portrait video 654 is immediately followed by a change in orientation of the media device and a landscape mode video 656 is captured. Landscape video 656 is 30 seconds in duration. The media device orientation sensors, such as a gyroscope, gravity sensor, and the like, provide information to the media device such that the orientation change from portrait mode to landscape mode is detected between video portions 654 and 656. After landscape video 656 is captured, a time break is seen before portrait video 658 is captured. Portrait video 658 is 20 seconds in duration.

The media device is inactive for a short time before four still images 660 are taken. The four still images are labeled S3, S4, S5, and S6. There is a longer time break 662 after the four still images 660 are taken. Here, it is assumed that the media device was transported to a different location. Here, a location sensor, such as in a Global Positioning System (GPS) receiver processor equipped media device, annotates the new location video 664 with location sensor data. Other sensor data may also be recorded such as orientation data. New location video 664 is 45 seconds in duration. There is a break in time and then three still images 666 are recorded by the media device. The images are labeled as S7, S8, and S9.

The entire original recording timeline may have occurred in any total duration. For the sake of example, a 30 minute timeline is provided as an example. During the 30 minute recording timeline, 126 seconds of video were recorded along with 9 still images. There were several orientation changes of the media device. These orientation changes were recorded as orientation sensor input changes and were annotated along with their respective video portions. At least one video portion, the new location video 664, was captured with an annotation of a location sensor change.

According to aspects of the invention, the media device can read the set of media recording timeline 610, which were stored in memory, and segment and order of the various portions of the recorded media. One such example ordering and segmentation is shown in example 620 of FIG. 6d.

The construction of example 620 results from the segmentation of the set of media recordings 610 and the ordering of the segments by the media device. The weighting used for segmentation and ordering in FIG. 6d derives from a default operation of the media device in processing the set of media recordings 610. Here, segmentation occurs in 16 second portions as an aspect of the invention. The specific order is the chronological order of the original set of media recordings 610.

In the segmentation and ordering of example 620, original portrait video portion 650 is 30 seconds in duration and is partitioned into two 16 second video segments (VS) labeled VS1 and VS2. Since two 16 second intervals are 32 seconds in total duration, the media device has added a total of 2 seconds to the total of VS1 and VS2. The added seconds can be a dwell on a few frames of the video to expand the video duration. In one aspect of the invention, the split between VS1 and VS2 may occur in one of a simple time division of the video portion 650, or a sensor split or a content detector split of the video portion 650.

In the content detector spilt option, the media device processing may find that two different subjects appear in the video portion 650 and each can be featured in a segment. If the split between the portrait video portions in 650 is based on a content detection split, then the split may be asymmetrical in time. For example, the raw split between two subjects of the content of video portion 650 could be 20 seconds and 10 seconds in the 30 second duration of video portion 650. In this event, according to aspects of the invention, the 20 second raw video portion of video portion 650 having the first subject can be edited down to fit a 16 second segment by removing 4 seconds of frames having no movement or removing 4 seconds of frames uniformly throughout the original 20 second subject interval. Thus, the video segment VS-1 may be formed.

For the second subject, which has a 10 second duration of video portion 650, the video segment generated is expanded to include an additional 6 seconds of video. This is accomplished by duplicating frames or dwelling on frames of the 10 second video portion to expend the segment to 16 seconds. This results in the generation of video segment VS2. As can be understood by those of skill in the art, the segmentation of raw video portion 650, having a 30 second duration, can be segmented into two 16 second video segments VS1 and VS1 using a numerical time division method and adding a total of two seconds to the combination of VS1 and VS2. Alternately, the segmentation of raw video portion 650, having a 30 second duration, can be segmented into two 16 second video segments VS1 and VS1 based on subject content wherein each segment is either expanded or shortened in time duration to generate two 16 second video segments VS1 and VS2. This general procedure is used for generation of multiple 16 second video segments of a raw video portion.

In an alternate embodiment, a user of the media device can utilize a user interface to mark or annotate the raw video portion of a video by reviewing the raw portion of the video, such as portion 650 and mark different subjects in the 30 second video. Then segmentation can occur based on the individual subject identified via the media device user interface. As above, each video segment produced would be 16 seconds long and the raw video portion corresponding to each identified subject would be expanded or shortened to fit within a 16 second video portion.

In the example 620, the order is a chronological order and thus, still images 652 labeled S1 and S2 in the raw video timeline 610 are used to create a single 16 second segment. This 16 second segment is shown in example 620 as a back to back combination of S1 and S2. Here, S1 was expanded by frame duplication or dwell into an 8 second portion and S2 was expanded by frame duplication or dwell into an 8 second portion. Their back to back position makes up a 16 second segment as shown in FIG. 6d.

Returning to the raw video timeline 610, note that video portions 654 and 656 are actually two portions of the same 45 second video. There is no time break between the video portions. Here, the total 45 second video portion (654 plus 656) can be divided into two portions because of the sensor information from an orientation sensor in the media device. The sensor information in video portion 654 is that of a portrait video. This portion lasts for 15 seconds. The sensor information then detects a change in orientation of the media device to the landscape mode or orientation in portion 656. This portion lasts for 30 seconds. Although the portions 654 and 656 are back to back, the orientation sensor information recorded along with the raw video in timeline 610 allows a segmentation to occur along a boundary defined by camera orientation of the media device.

Accordingly, raw portrait video portion 654, having a portrait orientation, is used to produce a video segment VS3. The VS 3 video segment is generated by expanding one or more frames of the raw 15 second portrait video 654 into a 16 second video section VS3. Raw video portion 656, having a landscape orientation, is used to generate video segments VS4 and VS5. As described above with respect to raw video section 650, the segments produced from video portion 656 can be apportioned based on a numerical split o the raw video portion 656, can be split into two video segments based on subject content, or can be split into two or more video segments based on a user mark of subjects. In any event, the example 620 depicts raw video portion 656 being segmented into two video segments VS4 and VS5.

Next, portrait video portion 658, having 20 seconds of duration, is segmented into one video segment VS6. This is accomplished by deleting 4 seconds of frames by deleting frames without motion or by deleting frames uniformly from the raw video portion 658. In any event, video segment VS6 is produced.

Addressed next are the four still images S3, S4, S5, and S6. Since the order is chronological, these four still images are arranged together, back to back in one 16 second segment as shown in FIG. 6d. Each of these four still images is dwelled upon for 4 seconds each to produce one 16 second segment.

The timeline 610 shows a time break 662. At raw video portion 664, a location sensor, such as a GPS location sensor, recorded a new location for the video that was captured. Here, location sensor information could have been used to establish a new segmentation, however, since there is also a chronological time break, that information also helps the initiation of a new segmentation. Video portion 664 is 45 seconds in duration. This 45 second raw video could be segmented into three 16 second segments totaling 48 seconds with 3 seconds of fill. However, in the example 620, analysis of the video by the media device indicates that much of the 45 second raw video portion 664 is video without movement. Accordingly, the segmentation process is able to delete 13 seconds of frames without losing content action. According to example 620, two 16 second segments VS7 and VS8 are generated for video portion 664.

In an alternate example, not shown, raw video portion 664 may have been segmented into at least three segments if there was sufficient on set of audio, such as an interview, even if there was no significant video movement. Thus, onsets such as the onset of audio, different scenes, and the like may also affect segmentation to preserve raw video portions that have changing content.

Finally, raw video portion 666 contains three still images S7, S8, and S9. According to the aspects of the invention, the three still images are grouped together in one 16 second segment shown at the end of example 620. The three still images are expanded to duplicate frames or dwell on each image for approximately 5 and one third seconds so that the segment time is filled at 16 seconds.

In FIG. 6d, the original cumulative video portion time in the set of media recordings is 140 seconds. The original set of still images in the media recordings is 9. At the example 620, segmentation has resulted in a total video segment time of 126 seconds and 48 seconds of still image segments. The time to consume all of the segmented video having original video content is shortened from 140 seconds to 126 seconds. The time to view the 9 still images is 48 seconds. However, with segmentation according to the present invention, a user of the media device can now select which segment he/she wishes to view to maximize their selection ability and video content viewing while minimizing the total time duration to view original video content.

According to an aspect of the invention, the user has the option of utilizing a user interface via the touch screen on the media device shown in FIG. 1 to affect segmentation and ordering. As described above, the user may affect segmentation by adding in annotations or break points into the raw video portions of timeline 610 to break up segmentation according to his/her desires. In addition, the order of the presentation of the full segmentation can be affected. Such results are shown in FIGS. 6b and 6c.

FIG. 6e illustrates the same second example original or raw video capture timeline 610 as shown in FIG. 6d. Generally, the same rules apply to the segmentation of the video portions of the raw video timeline 610. Thus video segments VS1 through VS8 are constructed similarly to that descried in FIG. 6d. However, the user of the media device has selected or asserted an option to organize the still images in a different order than the order of the straightforward chronological occurrence of timeline 610. According to an aspect of the invention, the user may elect to organize the generation of segments such that the still images are generated in just a few segments as after the video segments.

Thus, the first still segment SS1 is generated using still images S1, S2, and S3. Still segment SS1 is 16 seconds in duration where each still image is presented for approximately 5 and one third seconds. Likewise, the next still segment SS2 is generated using still images S4, S5, and S6. Still segment SS2 is 16 seconds in duration where each still image is presented for approximately 5 and one third seconds. Next, still segment SS3 is generated using still images S7, S8, and S9. Still segment SS3 is 16 seconds in duration where each still image is presented for approximately 5 and one third seconds. If a user wished to have the entire segmentation result 630 played back, the playback would display the video segments first and the still segments last. As before in the example 620 of FIG. 6d, the segmentation of example 630 of FIG. 6e results in a total video segment time of 126 seconds and 48 seconds of still image segments.

FIG. 6f is a third example of a segmentation and order arising from the current invention based on the second example set of media recordings in timeline 610. FIG. 6f illustrates the same original or raw video capture timeline 610 as shown in FIG. 6d. Generally, the same rules apply to the segmentation of the video portions of the raw video timeline 610. Thus video segments VS1 through VS8 are constructed similarly to that descried in FIG. 6d. However, the user of the media device has selected or asserted an option to organize the still images in a different order than the order of the straightforward chronological occurrence of timeline 610. According to an aspect of the invention, the user may elect to organize the generation of segments such that the still images are generated in just a few segments before the video segments. Thus, FIG. 6e and FIG. 6f differ in the order of the still and video segments.

In order to get the result of the FIG. 6f example 640, the user of the media device has selected to order the still segments before the presentation of the video segments. The video segments VS1 through VS8 are generated in the same manner as in FIG. 6e. The still segments SS1 through SS3 are also generated in the same manner as in FIG. 6e. However, the still segments are presented before the video segments according to a user request via the media device. As such, when the user plays back the entire segmented result 640, the still will be presented first and the videos will be presented thereafter. As before in the example 620 of FIG. 6e, the segmentation of example 640 of FIG. 6f results in a total video segment time of 126 seconds and 48 seconds of still image segments.

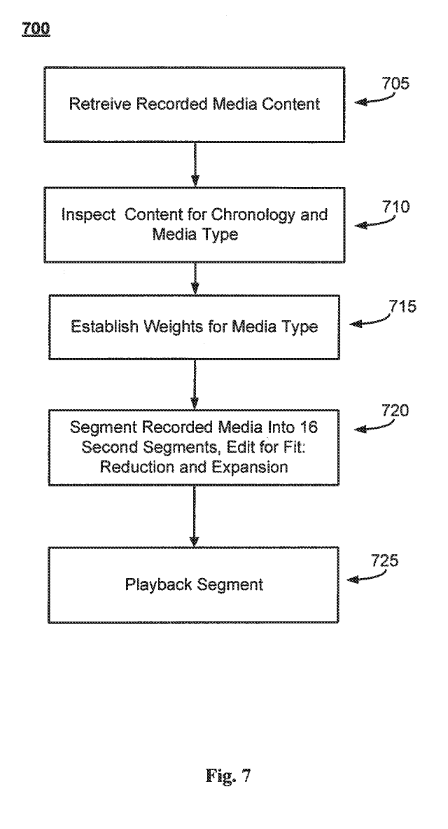

FIG. 7 illustrates a method 700 of segmentation of the first example set of media recordings 602 according to aspects of the invention corresponding to FIG. 6a, 6b, or 6c. The method 700 may be performed by a media device, such as the media device of FIG. 1. Initially, the first example set of media recordings 602 are captured by a media device. The media device can be a mobile phone, a tablet, a digital camera, and the like. The set of media recordings 602 are made and then stored into memory of the media device. The set of media recordings may be similar to the media portions shown in the media recordings 602 represented in FIG. 6a.

At step 705, the set of media recordings are retrieved as needed from memory and made accessible to the processor of the media device. The memory may form a part of the media device or may be external to the media device. At step 710, the set of media recordings are inspected for information and characteristics. Such inspection includes determining the chronology of the set of media recordings. The type of recording is also noted, such as whether the media recording is a still image (photo) or a video.

At step 715, the user preferences are noted with respect to the set of recordings. For example, user preferences include the setting of the slide bar control of an editing display. As discussed with respect to FIG. 6a, the slide bar control is utilized by a user to establish the weighting of the video portion 603 versus the weighting of the still image portion 605 of the set of media recordings 602. Thus, the slide bar control setting is read to indicate the weighting applied to the media type (603 versus 605) for purposes of segmentation of the set of video recordings 602.

Step 720 places the set of media recordings 602 into a segment. in the example of FIG. 6a, the segment 604 is 16 seconds in length and is generated by the weightings placed on the various characteristics (media type and chronology). In the example of FIG. 6a, the chronology is considered fixed but the weighting is a variable depending on the position that the user sets for the slide bar control of media type importance. In the example of FIG. 6a, the slide bar control setting indicates a strong preference (and weighting) for full video in the generated segment. As a consequence, the video portion of the recorded media is preserved during segmentation whereas the still image portion is reduced as earlier explained with respect to FIG. 6a. In the example of FIG. 6b, the slide bar control setting is at the full still image setting which indicates a strong preference (and weighting) for still image content and timing preservation during segmentation. In the FIG. 6b example, the segmented video is reduced to fit into the 16 second segment. In the FIG. 6c example, the slide bar control weighting is applied such that both the video portion 603 and the still image portion 605 is reduced.

Thus, at step 720, the weighting applied to the set of media recordings acts to alter the length of the video or alter the time between still images in the segmentation of the set media recordings in response to the position of the slide bar control. After the segment is generated, the segment, such as segment 604, 606, or 608 is made available for playback. The segment can then be played bask at the user's discretion.

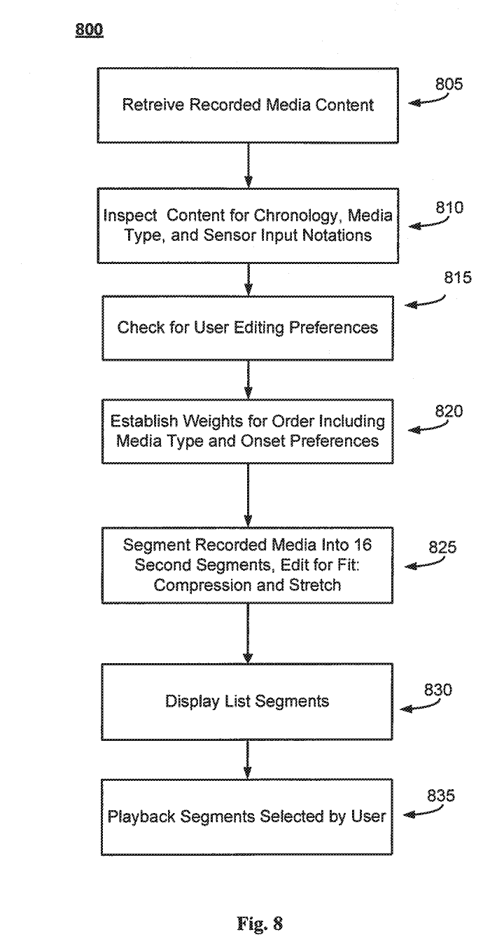

FIG. 8 illustrates a method 800 of segmentation and ordering (arranging) of the second example set of media recordings 610 according to aspects of the invention corresponding to FIG. 6d, 6e, or 6f. The method 800 may be performed by a media device, such as the media device of FIG. 1. Initially, the second set of media recordings are captured by a media device. The media device can be a mobile phone, a tablet, a digital camera, and the like. The set of media recordings are made and then stored into memory of the media device. The set of media recordings may be similar to the media portions shown in the recordings represented in timeline 610 of FIG. 6d.

At step 805, the set of media recordings are retrieved as needed from memory and made accessible to the processor of the media device. The memory may form a part of the media device or may be external to the media device. At step 810, the set of media recordings are inspected for information and characteristics. Such inspection includes determining the chronology of the set of media recordings as well as any sensor notations related to the set of media recordings. The type of recording is also noted, such as whether the media recording is a still image (photo) or a video. At step 815, user preferences are noted with respect to the set of recordings. For example, the user of the media device may have previously viewed the raw set of recordings and indicated via notations or markings in the recording where a new segmentation is preferred in some specific location of the video or audio portions of the recordings. Also noted are user preferences that indicate whether the order of presentation should be chronological, and which media type is placed first or last. Other user preferences include the importance to the user of the onset of audio in a media recording, the importance to a user of a change of camera orientation, the importance to a user of a change in location, and the importance to a user of a specific chronology, such as forwards, reverse, or mixed in that certain media recording portions are to be placed before other media recording portions.

Step 820 establishes weights for the ordering based on preferences provide or not provided by the user. Various weights may be placed on one or more of the media recording portions. For example, if the user selected still images as more important than video, then still images would be weighted more heavily than video portions. In addition, one video portion may be marked as being especially important in order and that video portion, after segmentation would be ordered first among the videos if the not the first video segment overall. Another example of weighting would be a user preference for a change of location videos which could alternate the order of videos between one location and the next. All or some of these types of user preferences may be weighted in step 820. In addition, a default set of preferences are present in the absence of specific user preferences. For example, one preference may be for a pure chronological order described in the example 620 of FIG. 6d. Another default preference could be for the ordering of segmented videos ahead of segmented still images. All such preferences, either user selected or default, are weighted in step 820. The established weights are then utilized by the processor to affect the order of the generated video segments.

Step 825 segments the set of media recordings into segments. The segments are 16 seconds in length and are generated by using the sensor and user notations in the set of media recording for each media portion of the set of media recordings. Segmentation order is affected by the weightings placed on the various characteristics and preferences described above such as importance of still images over video portions, one video portion over another, the characteristics of media type, chronology, orientation, and location. In addition, segmentation involves the expansion of frames of video or stills to fill up a 16 second segment as needed. Segmentation also involves the shortening of a video by the deletion of frames, such as those where no motion is present, so that a compact viewing of the segmented video is possible without tedium on the viewer.

After the segments are generated and ordered, a listing of the ordered segments is provided to a user or viewer on the media device at step 830. At step 835, the user of the media device can then select all segments, a few segments, or just one of the segments for playback. Thus, the user can view whatever segment he or she wishes in the order that is most preferred.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms. For example, implementation can be accomplished via a hardware apparatus, hardware and software apparatus. An apparatus may be implemented in, for example, appropriate hardware, software, and firmware. The methods may be implemented in an apparatus such as, for example, a processor, which refers to any processing device, including, for example, a computer, a microprocessor, an integrated circuit, or a programmable logic device.

Additionally, the methods may be implemented by instructions being performed by a processor, and such instructions may be stored on a processor or computer-readable media such as, for example, an integrated circuit, a software carrier or other storage device such as, for example, a hard disk, a compact diskette (“CD” or “DVD”), a random access memory (“RAM”), a read-only memory (“ROM”) or any other magnetic, optical, or solid state media. The instructions may form an application program tangibly embodied on a computer-readable medium such as any of the media listed above or known to those of skill in the art. Such instructions, when executed by a processor, allow an apparatus to perform the actions indicated by the methods described herein.

1. A method of segmenting a set of media recordings in a media device, the method comprising:
retrieving the set of media recordings from memory of the media device;
inspecting the set of media recordings for characteristics of the media recordings;
establishing weights for at least one of the characteristics;
segmenting the set of media recordings using the weighting of the characteristics;
playing the segmented media recordings on the media device.

2. The method of claim 1, wherein inspecting the set of media recordings for characteristics comprises inspecting for chronological order and media type.

3. The method of claim 2, wherein establishing weights for at least one of the characteristics comprises weighting the media type based on a user preference.

4. The method of claim 3, wherein the user preference is indicated by a position of a slide bar control.

5. The method of claim 1, wherein segmenting the set of media recordings comprises altering the length of a video portion during segment generation.

6. The method of claim 1, wherein segmenting the set of media recordings comprises altering the time between still images during segment generation.

7. The method of claim 1, wherein playing the segmented media recordings on the media device comprises displaying a generated segment on a display screen of the media device.

8. An apparatus for generating a set of media recordings and segmenting the set of media recordings, the apparatus comprising:
a camera for generating the set of media recordings;
a memory for storing the set of media recordings;
a processor, coupled to the memory, that segments the set of media recordings based on a weighted characteristic, wherein segmenting includes altering the length of a video or the time between still images in response to control input.

9. The apparatus of claim 8, wherein the apparatus is a mobile phone.

10. The apparatus of claim 8, wherein the control input is a slide bar control having a setting used for a determination of weighting media type for segmentation.

11. The apparatus of claim 8, further comprising a touch screen to display the slide bar control and receive the control input.

12. The apparatus of claim 8, wherein the processor segments the set of media recordings into a 16 second segment.

13. The apparatus of claim 8, wherein the weighted characteristic is media type.

14. A method of segmenting a set of media recordings, the method comprising:
retrieving the set of media recordings;
searching the set of media recordings for characteristics of the media recordings;
establishing weights for the characteristics;
establishing an order for the individual recordings in the set of media recordings according to the characteristics;
segmenting the set of media recordings using the weighting of the characteristics;
displaying a list of the segmented media recordings;
playing the segmented media recordings on a media device.

15. The method of claim 14, wherein receiving the set of media recordings comprises accessing the media recordings from a memory in the media device.

16. The method of claim 14, wherein searching the set of media recordings for characteristics comprises searching for chronological order, media type, and media sensor information associated with the set of media recordings.

17. The method of claim 16, wherein the media sensor information is one or more of movement and orientation, and location of a media recording device that generated the set of media recordings.

18. The method of claim 14, wherein establishing weights for the characteristics of the media recordings comprises determining if user preferences are present for the order of media type, orientation of recording device, location of a recording, and onset of a new recording item within the set of media recordings.

19. The method of claim 14, wherein establishing an order for the individual recordings in the set of media recordings comprises arranging an order for each individual recording in the set of media recordings with preference to user selection of media type preference, position, orientation, and onset of audio.

20. The method of claim 14, wherein segmenting the set of media recordings comprises arranging each individual media recording to be a fixed length segment, wherein a video segment is shortened by clipping unchanged scenes in a video recording and extending a presentation length of a still photo.

21. The method of claim 20, wherein a duration of a fixed length segment is 16 seconds.

22. The method of claim 14, wherein displaying a list of the segmented media recordings comprises displaying a list of the segmented media recordings in the established order for the individual recordings.

23. The method of claim 14, wherein playing the segmented media recordings on a media device comprises selecting and playing back all or a select number of segments under user direction on a mobile phone.

24. The method of claim 14, further comprising capturing the set of media recordings using a camera of a mobile phone.

25. An apparatus for generating a set of media recordings and segmenting the set of media recordings, the apparatus comprising:
a camera for generating the set of media recordings;
at least one sensor to detect location and orientation of the apparatus;
a memory for storing the set of media recordings;
a processor, coupled to the memory, that orders and segments the set of media recordings based on weighted characteristics, wherein segmenting includes using sensor information to indicate partitions for the segmenting.

26. The apparatus of claim 25, wherein the apparatus is a mobile phone.

27. The apparatus of claim 25, wherein the sensor information comprises at least one of location and orientation.

28. The apparatus of claim 25, further comprising a touch screen to receive user preferences for the order of portions of the set of media recordings, the user preferences establishing a weighting for the order of segmenting the set of media recordings.

29. The apparatus of claim 25, wherein the processor segments the set of media recordings into fixed length segments.

30. The apparatus of claim 29, wherein the fixed length segments are 16 seconds long each.

31. The apparatus of claim 25, wherein the weighted characteristics comprise apparatus location, apparatus orientation, the onset of audio associated with a video recording, the presence of a video recording, the presence of still photo recordings, and the chronological order of the set of media recordings.

32. The apparatus of claim 25, wherein the processor orders for the individual recordings in the set of media recordings by generating an order arrangement for each individual recording in the set of media recordings with preference to user selection of media type preference, position, orientation, and onset of audio.

33. The apparatus of claim 25, wherein the processor segments the set of media recordings by shortening or expanding each individual media recording to a fixed length segment, wherein a video segment is shortened by clipping unchanged scenes in a video recording and expanding a presentation length of a still photo.
